(19) United States
(12) Patent Application Publication
(10) Pub. No.: US 2022/0319724 A1
(43) Pub. Date: Oct. 6, 2022

(54) NUCLEAR REACTOR

(71) Applicant: MITSUBISHI HEAVY INDUSTRIES, LTD., Tokyo (JP)

(72) Inventors: Hideyuki Kudo, Tokyo (JP); Hironori Noguchi, Tokyo (JP); Koichi Tanimoto, Tokyo (JP); Yuichi Otani, Tokyo (JP); Yutaka Tanaka, Tokyo (JP); Takafumi Noda, Tokyo (JP); Kazuhiro Yoshida, Tokyo (JP); Hideyuki Sakata, Tokyo (JP); Tatsuo Ishiguro, Tokyo (JP); Hideaki Ikeda, Tokyo (JP); Satoru Kamohara, Tokyo (JP); Shohei Otsuki, Tokyo (JP); Nozomu Murakami, Tokyo (JP); Wataru Nakazato, Tokyo (JP); Takashi Hasegawa, Tokyo (JP); Tadakatsu Yodo, Tokyo (JP); Yasutaka Harai, Tokyo (JP); Shota Kobayashi, Tokyo (JP)

(73) Assignee: MITSUBISHI HEAVY INDUSTRIES, LTD., Tokyo (JP)

(21) Appl. No.: 17/424,543

(22) PCT Filed: Nov. 6, 2020
(86) PCT No.: PCT/JP2020/041587

§ 371 Date: Jul. 21, 2021

(30) Foreign Application Priority Data
Feb. 28, 2020 (JP) 2020-033418

(51) Int. Cl. G21C 1/32; G21C 5/16

(52) U.S. Cl. CPC G21C 1/32; G21C 5/16

(57) ABSTRACT

Ensuring a high output temperature while preventing leakage of radioactive substances, etc. A nuclear reactor includes a fuel unit; a shield unit that covers a circumference of the fuel unit for shielding from radioactive rays; and a heat conductive portion that penetrates the shield unit, is arranged such that the heat conductive portion extends to inside of the fuel unit and outside of the shield unit, and transfers heat of the fuel unit to the outside of the shield unit by solid heat conduction.

### FIELD

The present disclosure relates to a nuclear reactor.

### BACKGROUND

In a nuclear power generation system that uses nuclear fuels and generates electricity by utilizing heat from burnup collects heat that is generated in a nuclear reactor by circulation of a coolant, generates steam by using the collected heat, and generates electricity by rotating a turbine by the steam.

On the other hand, Patent Literature 1 describes a structure that collects heat that is generated in a nuclear reactor by heat pipes, performs thermal exchange between the heat pipes and a cooling system in which a coolant circulates, and generates electricity by using thermal energy that is collected by the cooling system. The structure described in Patent Literature 1 enables the coolant to circulate through the heat pipes that are set in a reactor core without external power supply, which makes it possible to increase reliability of a nuclear power generation system and reduce the size of the nuclear power generation system.

### CITATION LIST

### Patent Literature

Patent Literature 1: U.S. Pat. No. 2016/0027536

### SUMMARY

### Technical Problem

When a nuclear reactor in a small size like that described in Patent Literature 1 is used, it is preferable that to draw thermal energy efficiently.

In the case of a structure using heat pipes like that described in Patent Literature 1, a coolant having performed thermal exchange with fuels circulates through the heat pipes. Radioactive rays are generated in a nuclear reactor. In such a structure, when a damage occurs in the heat pipes, there is a risk that the coolant that is a radioactive substance having been irradiated with the radioactive rays in the heat pipes would leak into a system that is connected to a turbine. Liquid metal (alkali metal) is used for the coolant in the heat pipes and there is also a risk that the liquid metal would leak.

The present disclosure solves the problem described above and an object of the present disclosure is to provide a nuclear reactor that makes it possible to ensure a high output temperature while preventing leakage of radioactive substances, etc.

### Solution to Problem

In order to achieve the object, a nuclear reactor according to an aspect of the present disclosure includes a fuel unit; a shield unit that covers a circumference of the fuel unit to shield unit from radioactive rays; and a heat conductive portion that penetrates the shield unit, is arranged such that the heat conductive portion extends to inside of the fuel unit and outside of the shield unit, and transfers heat of the fuel unit to the outside of the shield unit by solid heat conduction.

### Advantageous Effects of Invention

The present disclosure makes it possible to draw heat that is generated by a fuel unit to the outside of a shield unit by solid heat conduction using a heat conductive portion. As a result, according to the present disclosure, it is possible to prevent leakage of radioactive substances, etc. In addition, because the heat conductive portion is arranged such that the heat conductive portion extends to the inside of the fuel unit and the outside of the shield unit, the present disclosure makes it possible to draw the heat that is generated by the fuel unit to the outside of the shield unit while reducing a distance of transmission of the heat. As a result, according to the present disclosure, it is possible to ensure a high output temperature.

### BRIEF DESCRIPTION OF DRAWINGS

FIG. 1 is a schematic diagram of a nuclear power generation system using a nuclear reactor according to an embodiment.

FIG. 2 is a schematic diagram illustrating a nuclear reactor according to a first embodiment.

FIG. 3 is a cross-sectional schematic diagram of the nuclear reactor according to the first embodiment.

FIG. 4 is an enlarged schematic partially-cut view of the nuclear reactor according to the first embodiment.

FIG. 5 is an enlarged schematic partially-cut view of the nuclear reactor according to the first embodiment.

FIG. 6 is an enlarged schematic partially-cut view of the nuclear reactor according to the first embodiment.

FIG. 7 is an enlarged schematic partially-cut view of the nuclear reactor according to the first embodiment.

FIG. 8 is an enlarged schematic partially-cut view of the nuclear reactor according to the first embodiment.

FIG. 9 is a schematic diagram illustrating a nuclear reactor according to a second embodiment.

FIG. 10 is a cross-sectional schematic diagram of the nuclear reactor according to the second embodiment.

FIG. 11 is an enlarged schematic partially-cut view of the nuclear reactor according to the second embodiment.

FIG. 12 is an enlarged schematic partially-cut view of the nuclear reactor according to the second embodiment.

FIG. 13 is a schematic diagram illustrating another mode of the nuclear reactor according to the second embodiment.

FIG. 14 is an enlarged schematic partially-cut view of the nuclear reactor according to the second embodiment.

FIG. 15 is an illustration of the mode illustrated in FIG. 14.

FIG. 16 is a schematic diagram illustrating another mode of the nuclear reactor according to the second embodiment.

FIG. 17 is a schematic diagram illustrating a nuclear reactor according to a third embodiment.

FIG. 18 is an enlarged schematic partially-cut view of the nuclear reactor according to the third embodiment.

### DESCRIPTION OF EMBODIMENTS

Embodiments according to the present disclosure will be described in detail below with reference to the drawings. The embodiments do not limit the present disclosure. The components in the embodiments described below cover ones that are easily replaceable by those skilled in the art or ones that are substantially the same.

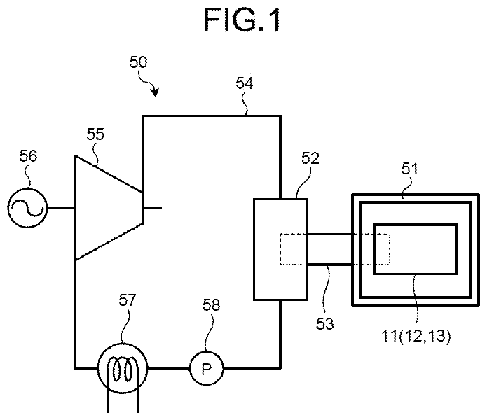

FIG. 1 is a schematic diagram of a nuclear power generation system using a nuclear reactor according to an embodiment. As illustrated in FIG. 1, a nuclear power generation system 50 includes a containment 51, a heat exchanger 52, a heat conductive portion 53, a coolant circulator 54, a turbine 55, a generator 56, a cooler 57, and a compressor 58.

The containment 51 includes a nuclear reactor 11 (12, 13) of an embodiment to be described below. The containment 51 houses the nuclear reactor 11 (12, 13). The containment 51 houses the nuclear reactor 11 (12, 13) in a sealed manner. In the containment 51, an open-close unit that is, for example, a cover is formed to house the nuclear reactor 11 (12, 13) to be placed inside or take out the nuclear reactor 11 (12, 13). The containment 51 makes it possible to maintain the sealed state even when burnup occurs in the nuclear reactor 11 (12, 13) and the inside is at a high temperature and a high pressure. The containment 51 is formed from a material with performance of shielding from neutrons.

The heat exchanger 52 performs heat exchange with the nuclear reactor 11 (12, 13). The heat exchanger 52 of the present embodiment collects heat of the nuclear reactor 11 (12, 13) via a solid high heat conducting material of the heat conductive portion 53 that is partly arranged inside the containment 51. The heat conductive portion 53 illustrated in FIG. 1 collectively refers to heat conductive portions 3, 103 and 104 and schematically illustrates the heat conductive portions 3, 103 and 104.

The coolant circulator 54 is a path for circulating a coolant and the heat exchanger 52, the turbine 55, the cooler 57, and the compressor 58 are connected to the coolant circulator 54. The coolant that flows through the coolant circulator 54 flows through the heat exchanger 52, the turbine 55, the cooler 57 and the compressor 58 in this order and the coolant having passed through the compressor 58 is supplied to the heat exchanger 52. Accordingly, the heat exchanger 52 performs heat exchange between the solid high heat conducting material of the heat conductive portion 53 and the coolant flowing through the coolant circulator 54.

The coolant having passed through the heat exchanger 52 flows into the turbine 55. The turbine 55 is rotated by the energy of the heated coolant. In other words, the turbine 55 converts the energy of the coolant into rotation energy and absorbs the energy from the coolant.

The generator 56 is joined to the turbine 55 and rotates integrally with the turbine 55. The generator 56 rotates together with the turbine 55 and thus generates electricity.

The cooler 57 cools the coolant having passed through the turbine 55. The cooler 57 is, for example, a condenser, or the like, in the case where a chiller or a coolant is temporarily liquidated.

The compressor 58 is a pump that pressurizes the coolant.

Using the heat conductive portion 53, the nuclear power generation system 50 transmits the heat that is generated by reaction of nuclear fuels (1A, 101A) in the nuclear reactor 11 (12, 13) to the heat exchanger 52. The nuclear power generation system 50 heats the coolant that flows through the coolant circulator 54 by the heat of the high heat transmission material of the heat conductive portion 53 in the heat exchanger 52. In other words, the coolant absorbs heat in the heat exchanger 52. Accordingly, the heat that is generated in the nuclear reactor 11 (12, 13) is collected by the coolant. After being compressed by the compressor 58, the coolant is heated when passing through the heat exchanger 52 and rotates the turbine 55 using the compressed and heated energy. Thereafter, the coolant is cooled by the cooler 57 to a reference state and is supplied again to the compressor 58.

As described above, the nuclear power generation system 50 transmits the heat that is drawn from the nuclear reactor 11 (12, 13) to the coolant serving as a medium that rotates the turbine 55 via the high heat conducting material. This makes it possible to isolate the nuclear reactor 11 (12, 13) from the coolant serving as a medium that rotates the turbine 55 and reduce a risk of contamination of the medium that rotates the turbine 55.

### First Embodiment

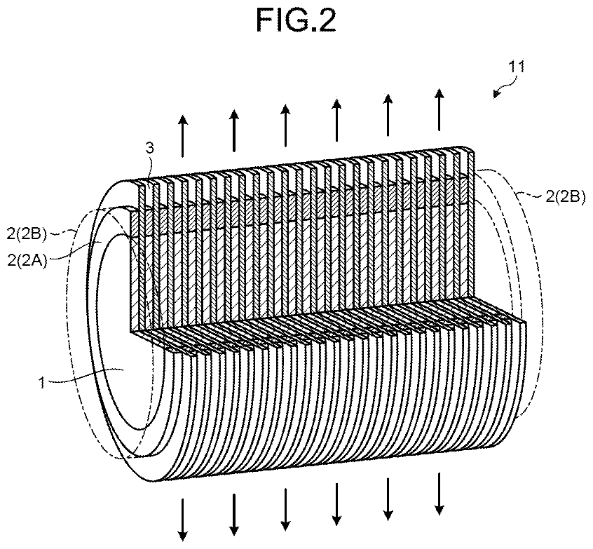

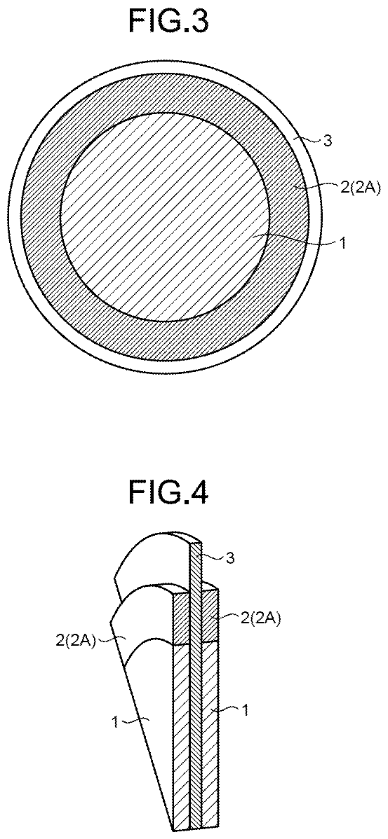

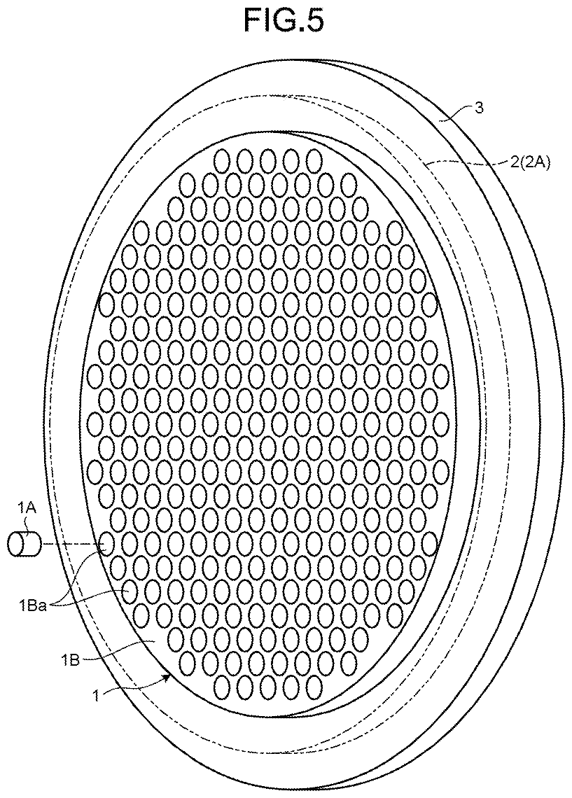

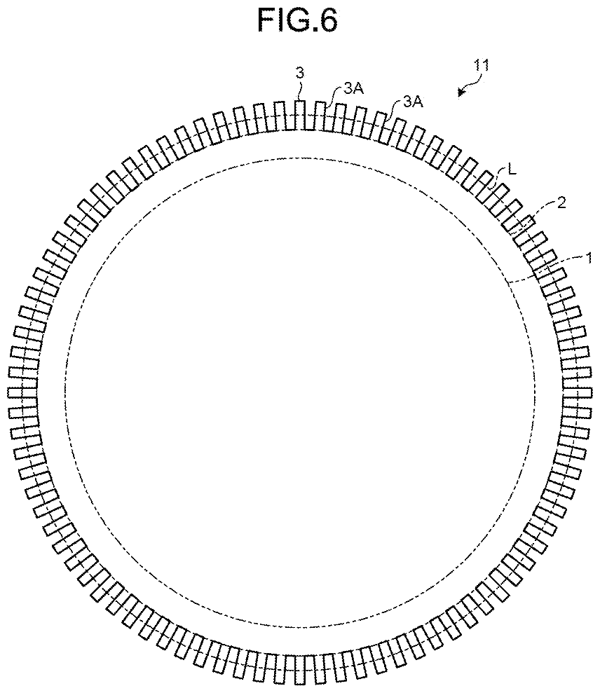

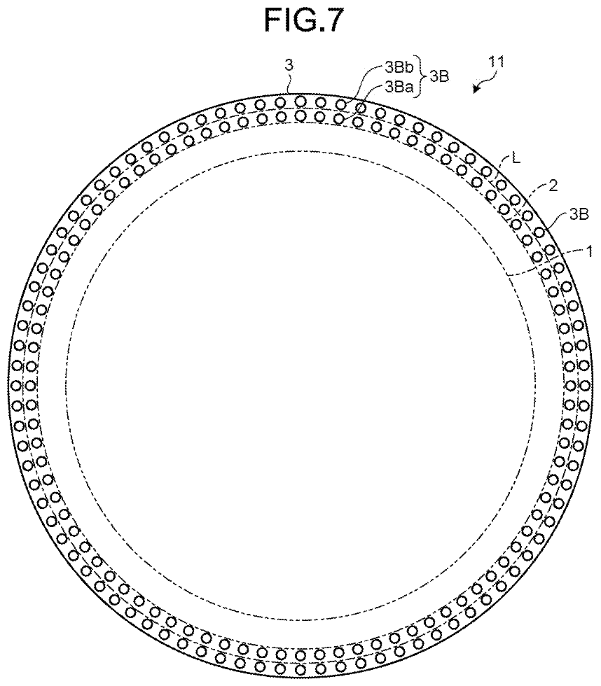

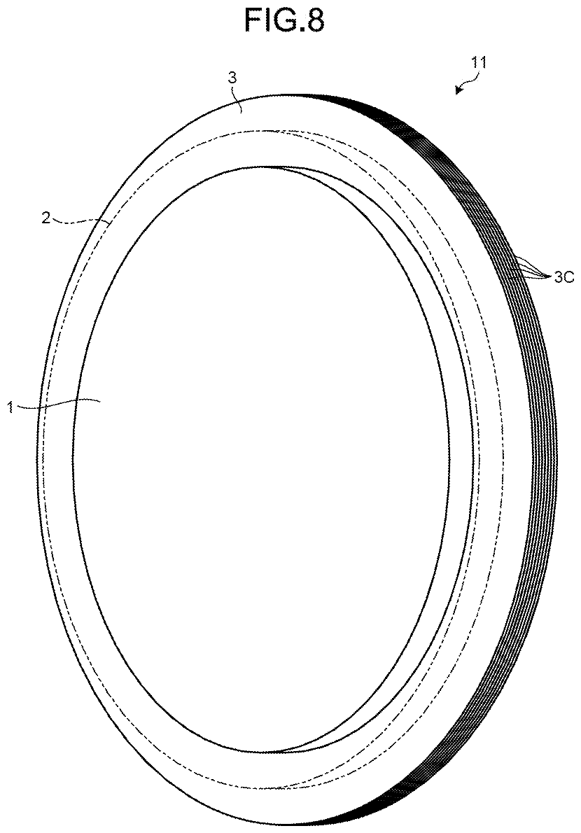

FIG. 2 is a schematic diagram illustrating a nuclear reactor according to a first embodiment. FIG. 3 is a cross-sectional schematic diagram of the nuclear reactor according to the first embodiment. FIG. 4 is an enlarged schematic partially-cut view of the nuclear reactor according to the first embodiment. FIG. 5 is an enlarged schematic partially-cut view of the nuclear reactor according to the first embodiment. FIG. 6 is an enlarged schematic partially-cut view of the nuclear reactor according to the first embodiment. FIG. 7 is an enlarged schematic partially-cut view of the nuclear reactor according to the first embodiment. FIG. 8 is an enlarged schematic partially-cut view of the nuclear reactor according to the first embodiment.

As illustrated in FIGS. 2 to 5, the nuclear reactor 11 includes a fuel unit (reactor core) 1, a shield unit 2, and the heat conductive portion 3.

In a fuel unit 1, nuclear fuels 1A that are illustrated in FIG. 5 are supported. Although not clearly illustrated, in the fuel unit 1, control rods that control burnup of the nuclear fuels 1A are arranged such that the control rods can be extracted and inserted. In the fuel unit 1, insertion of the control rods inhibits burnup of the nuclear fuels 1A. In the fuel unit 1, extraction of the control rods causes burnup of the nuclear fuels 1A.

The fuel unit 1 is formed in a form of a plate. In the present embodiment, the fuel unit 1 is formed in a form of a disk. A plurality of the fuel units 1 in the form of a plate are formed and are arranged alignedly such that the plate surfaces of the fuel units 1 are opposed to each other. The direction in which the fuel units 1 in the form of a plate are aligned with their plate surfaces opposed to each other may be referred to as an axial direction. As illustrated in FIG. 5, the fuel unit 1 includes the nuclear fuels 1A and a supporter 1B. The supporter 1B is formed in a form of a disk that is formed by the fuel unit 1. For the supporter 1B, for example, graphene is usable as a decelerator. For the supporter 1B, for example, graphite is usable as a decelerator. In the supporter 1B, a plurality of holes 1Ba are formed such that the holes 1Ba penetrate both plate surfaces in a form of plates. In the present embodiment, the hole 1Ba is formed in a form of a circle and is formed such that the hole 1Ba penetrates both the plate surfaces in the form of plates. The nuclear fuels 1A are formed such that the nuclear fuels 1A can be housed in the respective holes 1Ba. In the present embodiment, because the holes 1Ba are formed in the form circles, the nuclear fuels 1A are formed in a form of cylinders such that the nuclear fuels 1A can be housed in the holes 1Ba.

The shield unit 2 covers the circumference of the fuel unit 1. The shield unit 2 consists of a metal block and, by reflecting radioactive rays (neutrons) emitted from the nuclear fuel 1A, prevents the radioactive rays from leaking to the outside covering the fuel unit 1. The shield unit 2 may be referred to as a reflector according to the performance in scattering neutrons of a material used and absorbing neutrons.

The shield unit 2 includes a plurality of bodies 2A that are formed in a form of rings such that the bodies 2A surround the entire outer circumferences of respective plate ends of the fuel units 1 that are formed in a form of plates and covers 2B on both ends that are formed in a form of plates such that the covers 2B surround the sides of plate surfaces facing the outermost sides in the direction in which the fuel units formed in the form of plates are arranged. When the fuel units 1 is housed inside, the inside of the shield unit 2 that is a sealed structure may be filled with an inert gas, such as a gas nitride, for the purpose of preventing internal oxidation.

The heat conductive portion 3 penetrates the shield unit 2 and is inserted into the fuel units 1 that are arranged in the inside covered by the shield unit 2 and thus is arranged such that the heat conductive portion 3 extends to the inside of the fuel units 1 and the outside of the shield unit 2. The heat conductive portion 3 transfers heat that is generated by burnup of the nuclear fuels 1A of the fuel units 1 to the outside of the shield unit 2 by solid heat conduction. For the heat conductive portion 3, for example, graphene is usable. For the heat conductive portion 3, for example, titanium, nickel, copper or graphite is usable. The part of the heat conductive portion 3 extending to the outside of the shield unit 2 is arranged such that thermal exchange with the coolant is enabled in the containment 51.

The heat conductive portion 3 is formed in a form of a plate. In the present embodiment, the heat conductive portion 3 is formed in a form of a disk. The heat conductive portion 3 is formed on an outer circumference larger than that of the body 2A of the shield unit 2 and is arranged such that the heat conductive portion 3 extends to the outside of the shield unit 2. The direction in which the heat conductive portion 3 extends to the outside of the shield unit 2 may be a direction of receding from the center of the heat conductive portion 3 in the form of a disk and may be a radial direction. A plurality of the heat conductive portions 3 in the form of disks are formed and are arranged alignedly in the axial direction 3uch that, their plate surfaces are opposed to each other. The heat conductive portions 3 in the form of plates are arranged in an alternately superimposed manner in the axial direction such that the plate surfaces are opposed to the fuel units 1 in the form of plates.

Accordingly, the nuclear reactor 11 of the first embodiment makes it possible to, using the heat conductive portions 3, draw the heat that is generated by burnup of the nuclear fuels 1A of the fuel units 1 to the outside of the shield unit 2 by solid heat conduction. The heat that is drawn to the outside of the shield unit 2 is transmitted to the coolant and the turbine 55 is rotated.

As described above, the nuclear reactor 11 of the first embodiment makes it possible to, using the heat conductive portions 3, draw the heat of the nuclear fuels 1A of the fuel units 1 to the outside of the shield unit 2 by solid heat conduction (refer to the arrows in FIG. 2) and transmit the heat to the coolant. As a result, the nuclear reactor 11 of the first embodiment enables prevention of leakage of radioactive substances, etc. In the nuclear reactor 11 of the first embodiment, because the heat conductive portions 3 are arranged such that the heat conductive portions 3 extend to the inside of the fuel units 1 and the outside of the shield unit 2, it is possible to draw the heat of the nuclear fuels 1A of the fuel units 1 to the outside of the shield unit 2 while reducing the distance of transmission of the heat. As a result, the nuclear reactor 11 of the first embodiment makes it possible to ensure a high output temperature.

In the nuclear reactor 11 of the first embodiment, the fuel units 1 and the heat conductive portions 3 are formed in the form of plates and are arranged in an alternately superimposed manner such that the plate surfaces are opposed to each other and the heat conductive portions 3 in the form of plates are arranged such that the outer circumferential parts in the form of plates extend to the outside of the shield unit 2. Thus, the nuclear reactor 11 of the first embodiment can be in a mode where the heat conductive portions 3 penetrate the shield unit 2 and are arranged such that the heat conductive portions 3 extend to the inside of the fuel units 1 and the outside of the shield unit 2, which makes it possible to draw the heat of the fuel units 1 to the outside of the shield unit 2 by solid heat conduction. The thickness of the form of plates of the fuel units 1 and the thickness of the form of plates of the heat conductive portions 3 may be changed. Covering the outside of the shield unit 2 to which the heat conductive portions 3 do not extend with a heat insulating material makes it possible to increase efficiency in collecting heat using the heat conductive portions 3.

In the nuclear reactor 11 of the first embodiment, the fuel unit 1 includes the supporter 1B that is formed in the form of a plate and the nuclear fuels 1A that are arranged in the holes 1Ba formed in the supporter 1B. Accordingly, in the nuclear reactor 11 of the first embodiment in the mode where the fuel units 1 and the heat conductive portions 3 are formed in the forms of plates, it is possible to arrange the nuclear fuels 1A as appropriate along the plate surfaces of the heat conductive portions 3 in the form of plates and draw the heat of the fuel unit 1 to the outside of the shield unit 2 by solid heat conduction.

In the nuclear reactor 11 of the first embodiment, when the mode of the fuel unit 1 where the nuclear fuels 1A are arranged in the holes 1Ba that are formed in the supporter 1B is implemented, the density of the holes 1Ba in a center part of the form of a plate of the supporter 1B may be set lower than the density in an outer circumferential part. In other words, in the nuclear reactor 11 of the first embodiment, the fuel unit 1 may have a lower density in which the nuclear fuels 1A are arranged in the center part than in the outer circumferential part. In the configuration of the nuclear reactor 11 of the first embodiment, when the fuel unit 1 has a uniform density of arrangement of the nuclear fuels 1A, the temperature of the center part is higher than that of the outer circumferential part. The nuclear reactor 11 of the first embodiment has the configuration in which heat is drawn to the outer circumferential side in the radial direction of the fuel unit 1 and, in order to draw the heat easily, it is preferable that the temperature distribution of the nuclear fuels 1A be uniform. For this reason, setting the density of arrangement of the nuclear fuels 1A in the center part lower than that in the outer circumferential part in the fuel unit 1 enables uniform temperature distribution of the nuclear fuels 1A and makes it possible to easily draw heat.

As illustrated in FIG. 6, in the nuclear reactor 11 of the first embodiment, a plurality of cutouts 3A may be formed in the part of the heat conductive portion 3 that extends to the outside of the shield unit 2. The cutouts 3A are formed such that the cutouts 3A extend in the radial direction, receding from the outer surface of the shield unit 2 and the cutouts 3A are formed alignedly on the outer circumference of the heat, conductive portion 3 along the outer circumference of the shield unit 2. In other words, in the heat conductive portion 3, gaps that allow the coolant to pass are formed by the cutouts 3A in the part that extends to the outside of the shield unit 2 and in which heat exchange with the coolant circulating through the coolant circulator 54 for performing heat exchange in the heat exchanger 52. Accordingly, the nuclear reactor 11 of the first embodiment is able to increase efficiency of transmission of the heat that is drawn by the heat conductive portions 3 to the coolant.

In the heat conductive portion 3 that is formed such that the heat conductive portion 3 extends in the radial direction, receding from the outer surface of the shield unit 2, the heat that is drawn is high on an inner side in the radial direction that is close to the fuel unit 1 and is low on an outer side in the radial direction that is apart from the fuel unit 1. For example, in FIG. 6, when the heat conductive portion 3 that is formed such that the heat conductive portion 3 extends in the radial direction, receding from the outer surface of the shield unit 2, is divided into two areas in the radial direction by a virtual line L, the temperature of the drawn heat on the inner side in the radial direction with respect to the virtual line L is higher than that on the outer side in the radial direction. Thus, in the heat conductive portion 3, when heat exchange with the coolant is performed, the coolant is first passed through the outer side in the radial direction with respect to the virtual line L and then is returned and passed through the inner side in the radial direction with respect to the virtual line L and then the coolant is sent to the heat exchanger 52. This makes it possible to increase efficiency in transmitting the heat, that is drawn by the heat conductive portions 3 to the coolant.

In the nuclear reactor 11 of the first embodiment, as illustrated in FIG. 7, heat transmission pipes 3B that allows the coolant to flow may penetrate the part extending to the outside of the shield unit 2 in the heat conductive portion 3. A plurality of the heat transmission pipes 3B are formed alignedly on the outer circumference of the heat conductive portion 3 along the outer circumference of the shield unit 2. In other words, in the heat conductive portion 3, the heat transmission pipes 3B that allow the coolant to flow penetrate the part that extends to the outside of the shield unit 2 and in which heat exchange with the coolant that circulates through the coolant circulator 54 for performing heat exchange in the heat exchanger 52. Accordingly, the nuclear reactor 11 of the first embodiment transmits the heat that is drawn by the heat conductive portion 3 to the coolant via the heat transmission pipes 3B. The nuclear reactor 11 of the first embodiment transmits the heat that is drawn by the heat conductive portion 3 to the coolant indirectly via the heat transmission pipes 3B, which makes it possible to maintain shielding from radioactive rays.

In the heat conductive portion 3 that is formed such that the heat conductive portion 3 extends in the radial direction, receding from the outer surface of the shield unit 2, the heat that is drawn is high on the inner side in the radial direction that is close to the fuel unit 1 and is low on the outer side in the radial direction that is apart from the fuel unit 1. For example, in FIG. 7, when the heat conductive portion 3 that is formed such that the heat conductive portion 3 extends in the radial direction, receding from the outer surface of the shield unit 2, is divided into two areas in the radial direction by a virtual line L, the temperature of the drawn heat on the inner side in the radial direction with respect to the virtual line L is higher than that on the outer side in the radial direction. Thus, a plurality of the heat transmission pipes 3B contain a plurality of inner-side heat transmission pipes 3Ba that are arranged on the inner side in the radial direction with respect to the virtual line L and a plurality of outer-side heat transmission pipes 3Bb that are arranged on the outer side in the radial direction with respect to the virtual line L. In the heat conductive portion 3, when heat exchange with the coolant is performed, the coolant is first flown through the outer-side heat transmission pipes 3Bb, is returned and flown through the inner-side heat transmission pipes 3Ba, and is then sent to the heat exchanger 52. This makes it possible to increase efficiency in transmitting the heat that is drawn by the heat conductive portion 3 to the coolant.

In the nuclear reactor 11 of the first embodiment, as illustrated in FIG. 8, the heat conductive portion 3 may be formed in a form of a plate by laminating a plurality of plate members 3C in the axial direction overlapping the fuel unit 1. For the heat conductive portion 3, for example, graphene is usable and graphene has a structure of a continuous hexagonal grid that is formed of carbon atoms and by bonding the carbon atoms and has high transmittance of heat in the direction of the continuous hexagonal grid. This graphene is formed into the plate member 3C in a form of a sheet, so that the hexagonal lattice is continuous along the surface of the plate member 3C. The plate members 3C are laminated in the axial direction and are formed into the form of a plate. Accordingly, the heat conductive portion 3 has high heat transmittance in the radial direction along the surface of the plate members 3C. Thus, the heat conductive portion 3 has high heat transmittance to the part extending to the outside of the shield unit 2 in the radial direction. As a result, the nuclear reactor 11 of the first embodiment can increase efficiency of transmission of the heat that is drawn by the heat conductive portions 3 to the coolant.

### Second Embodiment

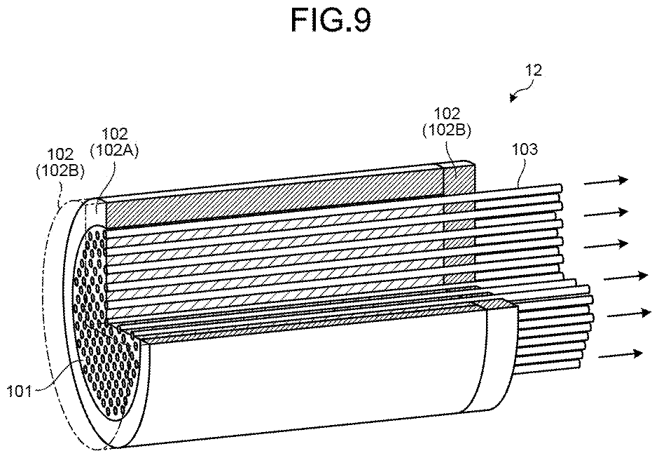

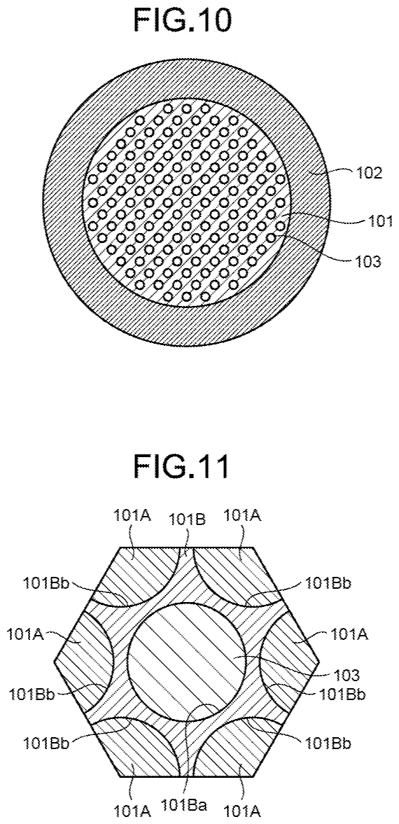

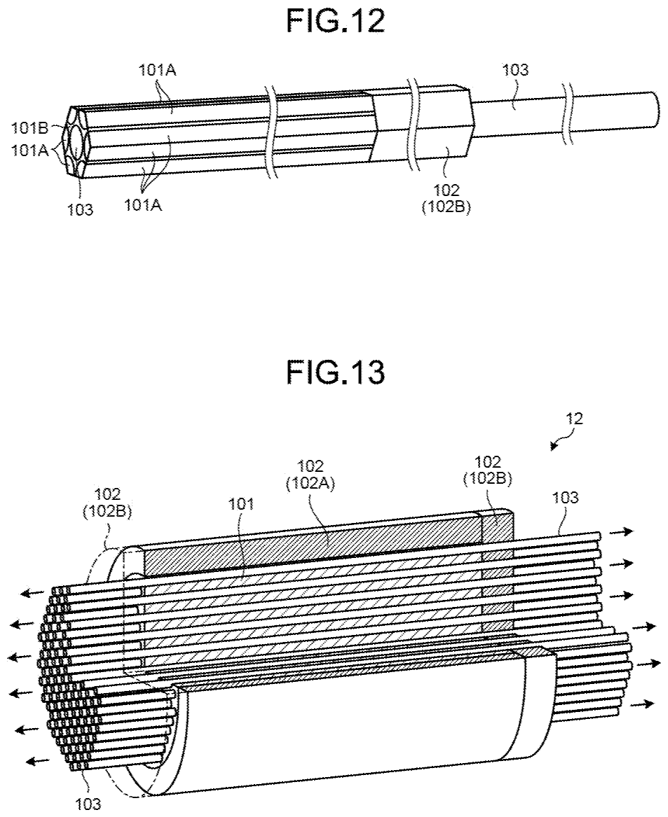

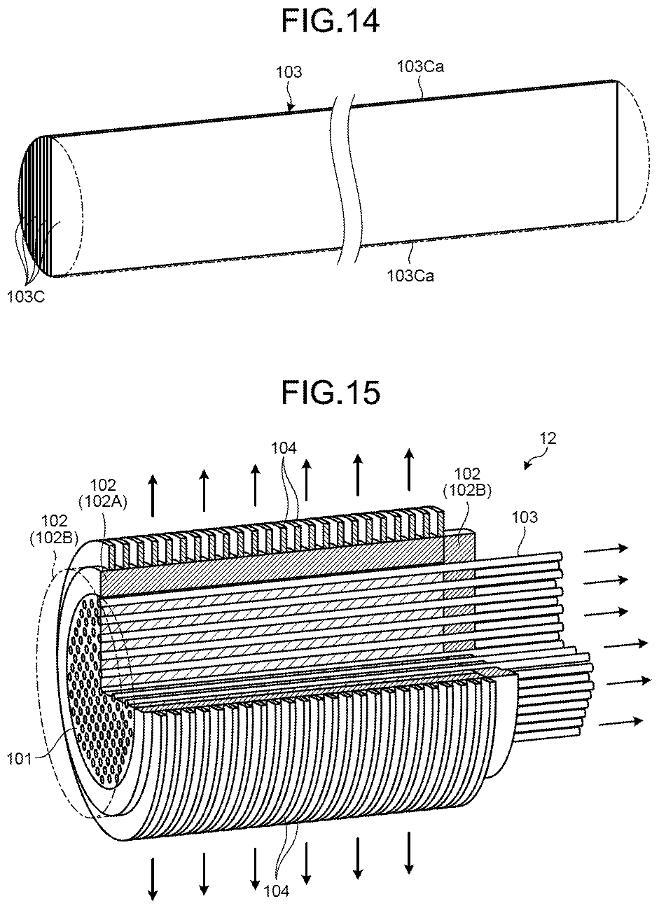

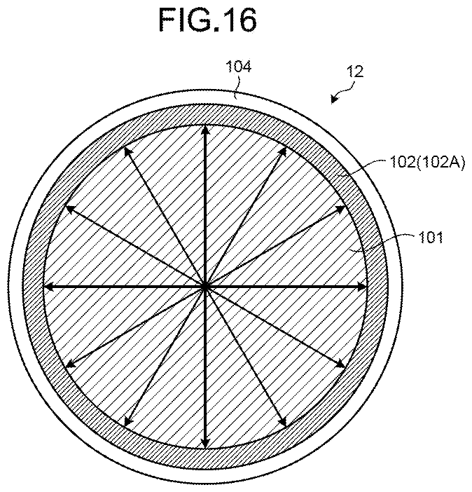

FIG. 9 is a schematic diagram illustrating a nuclear reactor according to a second embodiment. FIG. 10 is a cross-sectional schematic diagram of the nuclear reactor according to the second embodiment. FIG. 11 is an enlarged schematic partially-cut view of the nuclear reactor according to the second embodiment. FIG. 12 is an enlarged schematic partially-cut view of the nuclear reactor according to the second embodiment. FIG. 13 is a schematic diagram illustrating another mode of the nuclear reactor according to the second embodiment. FIG. 14 is an enlarged schematic partially-cut view of the nuclear reactor according to the second embodiment. FIG. 15 is an illustration of the mode illustrated in FIG. 14. FIG. 16 is a schematic diagram illustrating another mode of the nuclear reactor according to the second embodiment.

As illustrated in FIGS. 9 to 12, the nuclear reactor 12 contains a fuel unit (reactor core) 101, a shield unit 102, and the heat conductive portion 103.

In the fuel unit 101, nuclear fuels 101A illustrated in FIGS. 11 and 12 are supported. Although not clearly illustrated in the drawings, in the fuel unit 101, control rods that control burnup of the unclear fuels 101A are arranged such that the control rods can be extracted and inserted. In the fuel unit 101, inserting the control rods inhibits burnup of the nuclear fuels 101A. In the fuel unit 101, extracting the control rods causes bumup of the unclear fuels 101A.

The fuel unit 101 is formed in a form of a cylinder as a whole. In the present embodiment, the fuel unit 101 is formed approximately in a form of a cylinder. The direction in which the form of a cylinder extends may be referred to as an axial direction. The direction orthogonal to the axial direction may be referred to as a radial direction. As illustrated in FIGS. 11 and 12, the fuel unit 101 includes the nuclear fuels 101A and a supporter 101B. FIGS. 11 and 12 are schematic views of a cutout of the fuel unit 101 illustrated in FIG. 10 in a form of a prism with a hexagonal cross section. The supporter 101B is formed such that the supporter 101B extends in the axial direction, forming a dimension of the prism formed by the fuel unit 101 in the axial direction. In the supporter 101B, an insertion hole 101Ba into which the heat conductive portion 103 in a form of a rod to be described below is inserted is formed such that the insertion hole 101Ba penetrates in the axial direction. In the present embodiment, the insertion hole 101Ba is formed in a form having a circular cross section. In the supporter 101B, holes 101Bb in which the nuclear fuels 101A are arranged are formed around the insertion hole 101Ba such that the holes 101Bb penetrate in the axial direction. In the present embodiment, the holes 101Bb are formed in a form having a circular cross section. For the supporter 101B, for example, graphene is usable as a decelerator. For the supporter 101B, for example, graphite is usable as a decelerator. In the present embodiment, the nuclear fuels 101A are formed in a form of rods having a circular cross-sectional shape and continuous in the axial direction such that the nuclear fuels 101A are arranged in the holes 101Bb of the supporter 101B. The nuclear fuels 101A in the form of rods can be formed by inserting nuclear fuels in a form of pellets into cylinders having the above-described circular cross-sectional form.

The shield unit 102 covers the circumference of the fuel unit 101. The shield unit 102 consist of a metal block and, by reflecting radioactive rays (neutrons) emitted from the nuclear fuels 101A, prevents the radioactive rays from leaking to the outside covering the fuel unit 101. The shield unit 102 may be referred to as a reflector according to the performance in scattering neutrons of a material used and absorbing neutrons.

The shield unit 102 includes a body 102A that is formed in a form of a cylinder such that the body 102A surrounds the entire outer circumference of the fuel unit 101 in a form of a cylinder and covers 102B respectively covering both ends of the body 102A. When the fuel unit 101 is housed inside, the inside of the shield unit 102 that is a sealed structure may be filled with an inert gas, such as a gas nitride, for the purpose of preventing internal oxidation.

The heat conductive portions 103 penetrate the shield unit 102 and are inserted into the fuel unit 101 that is arranged in the inside covered by the shield unit 102 and thus is arranged such that the heat conductive portions 103 extend to the inside of the fuel units 1 and the outside of the shield unit 102. The heat conductive portions 103 transfers heat that is generated by burnup of the nuclear fuels 101A of the fuel unit 101 to the outside of the shield unit 102 by solid heat conduction. For the heat conductive portions 103, for example, graphene is usable. For the heat conductive portions 103, for example, titanium, nickel, copper or graphite is usable. The part of the heat conductive portion 103 extending to the outside of the shield unit 102 is arranged such that thermal exchange with the coolant is enabled in the containment 51.

The heat conductive portion 103 is formed in a form of a rod extending in the axial direction- In the present embodiment, the heat conductive portion 3 is formed in a form of a rod whose cross section is circular. The heat conductive portion 103 is inserted into the insertion hole 101Ba that is formed in the supporter 101B in the fuel unit 101, penetrates one of the covers 102B of the shield unit 102, and is arranged such that the heat conductive portion 3 extends to the outside of the shield unit 102.

Accordingly, the nuclear reactor 12 of the second embodiment makes it possible to, using the heat conductive portions 103, draw the heat that is generated by burnup of the nuclear fuels 101A of the fuel units 101 to the outside of the shield unit 2 by solid heat conduction. The heat that is drawn to the outside of the shield unit 102 is transmitted to the coolant and the turbine 55 is rotated.

As described above, in the nuclear reactor 12 of the second embodiment makes it possible to, using the heat conductive portions 103, draw the heat of the nuclear fuels 101A of the fuel unit 101 to the outside of the shield unit 102 by solid heat conduction (refer to the arrows in FIG. 9) and transmit the heat to the coolant. As a result, the nuclear reactor 12 of the second embodiment enables prevention of leakage of radioactive substances, etc. In the nuclear reactor 12 of the second embodiment, because the heat conductive portions 103 are arranged such that the heat conductive portions 103 extend to the inside of the fuel unit 1 and the outside of the shield unit 102, it is possible to draw the heat of the nuclear fuels 101A of the fuel unit 101 to the outside of the shield unit 102 while reducing the distance of transmission of the heat. As a result, the nuclear reactor 12 of the second embodiment makes it possible to ensure a high output temperature.

In the nuclear reactor 12 of the second embodiment, the fuel unit 101 includes the nuclear fuels 101A that are formed in the form of rods and the supporter 101B that supports the nuclear fuels 101A in the form of rods and the heat conductive portions 103 are formed in the form of rods, are arranged alignedly such that the heat conductive portions 103 extend along the direction in which the nuclear fuels 101A extend, penetrate the supporter 101B and are supported. Thus, the nuclear reactor 12 of the second embodiment can be in a mode where the heat conductive portions 103 penetrate the shield unit 102 and are arranged such that the heat conductive portions 3 extend to the inside of the fuel unit 101 and the outside of the shield unit 102, which makes it possible to draw the heat of the fuel unit 1 to the outside of the shield unit 102 by solid heat conduction. The diameter of the heat conductive portions 103 in the form of rods may change. Covering the outside of the shield unit 102 to which the heat conductive portions 103 do not extend with a heat insulating material makes it possible to increase efficiency in collecting heat using the heat conductive portions 103.

In the nuclear reactor 12 of the second embodiment, as described above, the heat conductive portions 103 are formed into the form of rods, extend in the axial direction along the direction in which the nuclear fuels 101A extend, penetrate the cover 102B of the shield unit 102, and are arranged outside the shield unit 102. In the configuration, when the density of arrangement of the nuclear fuels 101A is uniform, the temperature of a center part is higher than that of an outer circumferential part. For this reason, when heat exchange with the coolant is performed in the heat conductive portion 103, the coolant is first passed through the part of the heat conductive portion 103 on the outer side in the radial direction and is then passed through the part of the heat conductive portion 103 on the inner side in the radial direction and then the coolant is sent to the heat exchanger 52. This makes it possible to increase efficiency in transmitting the heat that is drawn by the heat conductive portions 103 to the coolant. When the density of arrangement of the nuclear fuels 1A is uniform, because the temperature of the center part is higher than that of the outer circumferential part but the area of the center part is small and efficiency in drawing heat lowers, the diameter of the heat conductive portions 103 in the form of rods in the center part of the fuel unit 101 may be increased or the arrangement interval may be reduced in order to increase the density of the heat conductive portions 103 in the center part. Increasing the density of arrangement of the nuclear fuels 101A in the outer circumferential part of the fuel unit 101 in a large area makes it possible to increase efficiency in drawing heat in the part in a large area. In this case, the diameter of the heat conductive portions 103 in the form of rods may be increased or the arrangement interval may be reduced in the outer circumferential part of the fuel unit 101 in order to increase the density of the heat conductive portions 103 in the outer circumferential part of the fuel unit 101.

In the nuclear reactor 12 of the second embodiment, as illustrated in FIG. 13, the heat conductive portions 103 may penetrate the fuel unit 101 and may be arranged such that the heat conductive portions 103 extend to each of outsides on opposite sides to the shield unit 102. In other words, in the nuclear reactor 12 illustrated in FIG. 13, the heat conductive portions 103 penetrate both the covers 102B of the shield unit 102, extend in the axial direction, and are arranged on each of the outsides on opposite sides to the shield unit 102. Thus, the nuclear reactor 12 of the second embodiment makes it possible to draw the heat of the fuel unit 101 to each of the outsides on opposite sides to the shield unit 102 by solid heat conduction (refer to the arrows in FIG. 13).

In the nuclear reactor 12 of the second embodiment, as illustrated in FIG. 14, the heat conductive portion 103 may be formed in a form of a rod by laminating plate members 103C that are continuous in the direction in which the form of a rod extends. For the heat conductive portion 103, for example, graphene is usable and graphene has a structure of a continuous hexagonal grid that is formed of carbon atoms and by bonding the carbon atoms and has high transmittance of heat in the direction of the continuous hexagonal grid. This graphene is formed into the plate member 103C in a form of a sheet, so that the hexagonal lattice is continuous along the surface of the plate member 103C. The plate members 103C are laminated and formed into the form of a rod. Accordingly, the heat conductive portion 103 has high heat transmittance in the axial direction that is the direction in which the form of a rod extends along the surface of the plate member 103C. Thus, the heat conductive portion 103 has high heat transmittance to the part extending to the outside of the shield unit 102 in the axial direction. As a result, the nuclear reactor 12 of the second embodiment can increase efficiency of transmission of the heat that is drawn by the heat conductive portion 103 to the coolant.

As illustrated in FIG. 15 and FIG. 16, the nuclear reactor 12 of the second embodiment may contain another heat conductive portion 104 that is attached on the outside of the shield unit 102 to which the heat conductive portions 103 do not extend. In the present embodiment, the shield unit 102 to which the heat conductive portions 103 do not extend refers to the body 102A and another heat conductive portion 104 is attached on the outside of the body 102A. As illustrated in FIG. 15 and FIG. 16, another heat conductive portion 104 is formed in a form of a ring surrounding the body 102A of the shield unit 102 and other heat conductive portions 104 are attached alignedly in the axial direction. Although not clearly illustrated in the drawings, another heat conductive portion 104 may be formed in a form of a plate extending in the axial direction and other conductors 104 may be attached alignedly such that the conductors 104 surround the body 102A of the shield unit 102. For other heat conductive portions 104, for example, graphene is usable. For other heat conductive portions 104, for example, titanium, nickel, copper or graphite is usable. Forming other heat conductive portions 104 makes it possible to draw heat also from the outside of the shield unit 102 to which the heat conductive portions 103 do not extend (refer to the arrows in FIG. 15). As explained with reference to FIG. 6 and FIG. 7 in the first embodiment, when heat exchange of the heat that is drawn by other heat conductive portions 104 with the coolant is performed, the coolant is first passed through on the outer side in the radial direction and is then passed through on the inner side in the radial direction and then the coolant is sent to the heat exchanger 52.

In the nuclear reactor 12 of the second embodiment, in the mode where the heat conductive portion 103 is formed in the form of a rod by laminating the plate members 103C that are continuous in the direction in which the form of a rod extends, ends 103Ca of the plate member 103C forming a circumferential surface of the form of a rod may be arranged such that the ends 103Ca are oriented to other heat conductive portions 104 that are attached on the outside of the shield unit 102. In the heat conductive portion 103, like that illustrated in FIG. 14, that is formed into the form of a rod by laminating the surfaces of the plate members 103C that are continuous in the direction in which the form of a rod extends, the ends 103Ca of the plate member 103C forming the circumferential surface of the form of a rod face in opposite directions along the surface of the plate member 103C. As indicated by the arrows in FIG 16, the ends 103Ca of the plate member 103C are arranged such that the ends 103Ca are oriented to other heat conductive portions 104 that are attached on the outside of the shield unit 102. As described above, the heat conductive portion 103 has high transmittance of heat along the surfaces of the plate members 103C. For this reason, orienting the ends 103Ca that face in the opposite directions along the surface of the plate member 103C to other heat conductive portions 104 increases transmittance of heat to other heat conductive portions 104. As a result, the nuclear reactor 12 of the second embodiment makes it possible to, using other heat conductive portions 104, efficiently draw the heat that is drawn by the heat conductive portions 103 and thus increase efficiency in transmitting the heat to the coolant.

### Third Embodiment

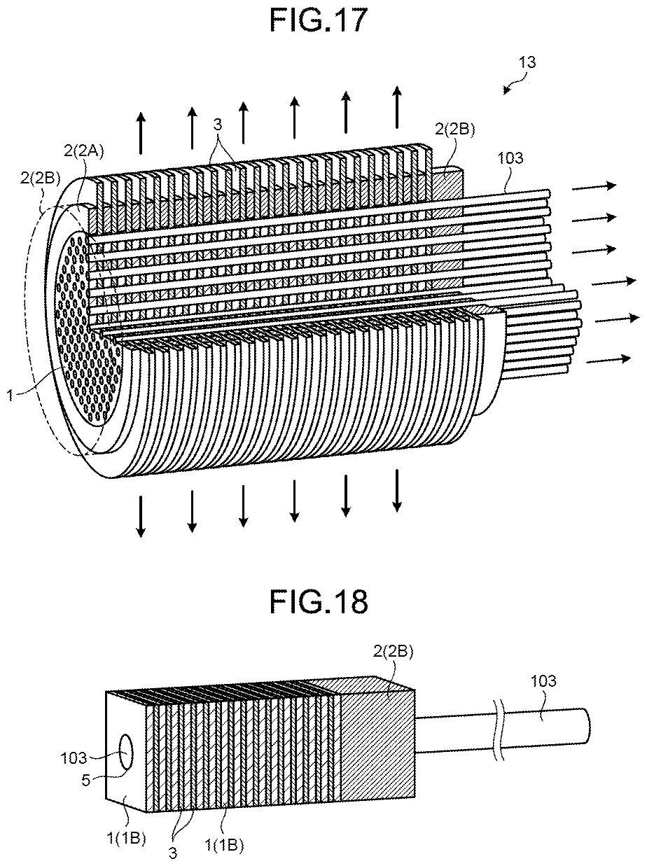

FIG. 17 is a schematic diagram illustrating a nuclear reactor according to a third embodiment. FIG. 18 is an enlarged schematic partially-cut view of the nuclear reactor according to the third embodiment.

A nuclear reactor 13 of the present embodiment is a combination of the configuration of the nuclear reactor 11 of the first, embodiment and the configuration of the nuclear reactor 12 of the second embodiment that are described above. Thus, the same components as those of the nuclear reactor 11 and the nuclear reactor 12 are denoted with the same reference numbers and description thereof will be omitted.

The nuclear reactor 13 of the present embodiment includes the fuel unit 1, the shield unit 2 and the heat conductive portion (first heat conductive portion) 3 of the nuclear reactor 11 of the first embodiment and the heat conductive portion (second heat conductive portion) 103 of the nuclear reactor 12 of the second embodiment.

In other words, in the nuclear reactor 13, a hole 5 into which the heat conductive portion 103 is inserted is formed in the supporter 1B of the fuel unit 1 and the heat conductive portion 3.

As described above, in the nuclear reactor 13 of the third embodiment, the fuel unit 1 includes the supporter 1B that is formed in a form of a plate and the nuclear fuels 1A that are supported by the supporter 1B, and a heat conductive portion includes the first heat conductive portion 3 that is formed in a form of a plate and that is arranged in an alternately superimposed manner such that the first heat conductive portion 3 is opposed to the plate surface of the supporter 1B and the second heat conductive portion 103 that is formed in a form of a rod and that is arranged such that the second heat conductive portion 103 extends in a direction in which the supporter 1B and the first heat conductive portion 3 overlap. Accordingly, the nuclear reactor 13 of the third embodiment can be in a mode where the first heat conductive portions 3 and the second heat conductive portions 103 penetrate the shield unit 2 and are arranged such that the first heat conductive portions 3 and the second heat conductive portions 103 extend to the inside of the fuel units 1 and the outside of the shield unit 2, which makes it possible to draw heat of the fuel units 1 to the outside of the shield unit 2 by solid heat conduction.

The fuel unit 1 may include the nuclear fuel (first nuclear fuel) 1A that is arranged in the hole 1Ba that is formed in the supporter 1B. The fuel unit 1 may include the nuclear fuel (second nuclear fuel) 101A that is inserted into a hole 5 that is formed in a form of a rod and that is formed in the supporter 1B and the hole 5 that is formed in the first heat conductive portion 3 and that is arranged along the direction in which the second heat conductive portion 103 extends. Accordingly, the nuclear reactor 13 of the third embodiment can be in a mode where the second heat conductive portion 3 and the second heat conductive portion 103 penetrate the shield unit 2 and are arranged such that the second heat conductive portion 3 and the second heat conductive portion 103 extend to the inside of the nuclear unit 1 and the outside of the shield unit 2, which makes it possible to draw the heat of the fuel unit 1 to the outside of the shield unit 2 by solid heat conduction (refer to the arrows in FIG. 17).

In the nuclear reactor 13 of the third embodiment, the cutouts 3A may be formed in a part of the first heat conductive portion 3 that extends to the outside of the shield unit 2. Accordingly, it is possible to obtain the same function and effect as those of the first embodiment.

In the nuclear reactor 13 of the third embodiment, the heat transmission pipes 3B (3Ba, 3Bb) that flow the first coolant may be inserted into a part of the first heat conductive portion 3 that extends to the outside of the shield unit 2. Accordingly, it is possible to obtain the same function and effect as those of the first embodiment.

In the nuclear reactor 13 of the third embodiment, the first heat conductive portion 3 may be formed in a form of a plate by laminating the plate members 3C in the direction in which the first heat conductive portion 3 overlaps the fuel unit 1. Accordingly, it is possible to obtain the same function and effect as those of the first embodiment.

In the nuclear reactor 13 of the third embodiment, the second heat conductive portion 103 may penetrate the fuel unit 1 and may be arranged such that the second heat conductive portion 103 extends to each of outsides of both the covers 102B on opposite sides to the shield unit 2. Accordingly, it is possible to obtain the same function and effect as those of the second embodiment.

In the nuclear reactor 13 of the third embodiment, the second heat conductive portion 103 may be formed in a form of a rod by laminating the plate members 103C continuous in the direction in which the form of a rod extends. Accordingly, it is possible to obtain the same function and effect as those of the second embodiment.

In the nuclear reactor 13 of the third embodiment, the second heat conductive portion 103 may be arranged such that the ends 103Ca of the plate member 103C forming the circumferential surface of the form of a rod are oriented to the outside of the shield unit 2 along the plate surface of the first heat conductive portion 3 in the form of a plane. The second heat conductive portion 103 has high transmittance of heat along the surface of the plate member 103C. Thus, orienting the ends 103Ca facing in opposite directions along the plate surface of the plate member 103C to the outside of the shield unit 2 along the plane surface of the first heat conductive portion 3 in the form of a plate increases transmittance of heat of the first heat conductive portion 3 to the outside of the shield unit. As a result, the nuclear reactor 13 of the third embodiment makes it possible to efficiently draw heat using the first heat conductive portions 3 and thus increase efficiency in transmitting the heat to the coolant.

### REFERENCE SIGNS LIST

11, 12, 13 nuclear reactor

1 fuel unit

1A nuclear fuel

1B supporter

1Ba hole

2 shield unit

3 heat conductive portion (first heat conductive portion)

3A cutout

3B heat transmission pipe

3Ba inner-side heat transmission pipe

3Ba outer-side heat transmission pipe

3C plate member

5 hole

101 fuel unit

101A nuclear fuel

101B supporter

102 shield unit

103 heat conductive portion (second heat conductive portion)

103C plate member

103Ca end

104 other heat conductive portion

1. A nuclear reactor comprising:
a fuel unit;
a shield unit that covers a circumference of the fuel unit to shield unit from radioactive rays; and
a heat conductive portion that penetrates the shield unit, is arranged such that the heat conductive portion extends to inside of the fuel unit and outside of the shield unit, and transfers heat of the fuel unit to the outside of the shield unit by solid heat conduction.

2. The nuclear reactor according to claim 1, wherein the fuel unit and the heat conductive portion are formed into a form of plates and are arranged in an alternately superimposed manner such that plate surfaces of the fuel unit and the heat conductive portion are opposed to each other and the heat conductive portion in the form of a plate is arranged such that an outer circumferential part of the form of a plate extends to the outside of the shield unit.

3. The nuclear reactor according to claim 2, wherein the fuel unit includes a supporter that is formed in a form of a plate and a nuclear fuel that is arranged in a hole formed in the supporter.

4. The nuclear reactor according to claim 2, wherein a plurality of cutouts are formed in a part of the heat conductive portion that extends to the outside of the shield unit.

5. The nuclear reactor according to claim 2, wherein a heat transmission pipe that flows a coolant penetrates a part of the heat conductive portion that extends to the outside of the shield unit.

6. The nuclear reactor according to claim 2, wherein the heat conductive portion is formed into a form of a plate by laminating a plurality of plate members in a direction in which the heat conductive portion overlaps the fuel unit.

7. The nuclear reactor according to claim 1, wherein the fuel unit includes a plurality of nuclear fuels that are formed in a form of rods and a supporter that supports the nuclear fuels in the form of rods, and
a plurality of the heat conductive portions are formed into a form of rods, are arranged such that the heat conductive portions extend along a direction in which the nuclear fuels extend, penetrate the supporter, and are supported.

8. The nuclear reactor according to claim 7, wherein the heat conductive portion penetrates the fuel unit and is arranged such that the heat conductive portion extends to each of outsides on opposite sides to the shield unit.

9. The nuclear reactor according to claim 7, wherein the heat conductive portion is formed in a form of a rod by laminating plate members that are continuous in a direction in which the form of a rod extends.

10. The nuclear reactor according to claim 7, further comprising another heat conductive portion that is attached on the outside of the shield unit to which the heat conductive portion does not extend.

11. The nuclear reactor according to claim 10, wherein the heat conductive portion is formed in a form of a rod by laminating plate members that are continuous in a direction in which the form of a rod extends and ends of the plate member forming a circumferential surface of the form of a rod are arranged such that the ends are oriented to the other heat conductive portion that is attached on the outside of the shield unit.

12. The nuclear reactor according to claim 1, wherein the fuel unit includes a supporter that is formed in a form of a plate and a nuclear fuel that is supported by the supporter, and
the heat conductive portion includes
a first heat conductive portion that is formed in a form of a plate and is arranged in an alternately superimposed manner such that the first heat conductive portion is opposed to a plate surface of the supporter, and
a second heat conductive portion that is formed in a form of a rod and is arranged such that the second heat conductive portion extends in a direction in which the supporter and the first heat conductive portion overlap.

13. The nuclear reactor according to claim 12, wherein the nuclear fuel of the fuel unit includes a first nuclear fuel that is arranged in a hole formed in the supporter.

14. The nuclear reactor according to claim 12, wherein the nuclear fuel of the fuel unit includes a second nuclear fuel that is inserted into a hole formed in a form of a rod and formed in the supporter and a hole formed in the first heat conductive portion, the second nuclear fuel being arranged along the direction in which the second heat conductive portion extends.

15. The nuclear reactor according to claim 12, wherein a plurality of cutouts are formed in a part of the first heat conductive portion that extends to the outside of the shield unit.

16. The nuclear reactor according to claim 12, wherein a heat transmission pipe that flows a coolant penetrates a part of the first heat conductive portion that extends to the outside of the shield unit.

17. The nuclear reactor according to claim 12, wherein the first heat conductive portion is formed into a form of a plate by laminating a plurality of plate members in a direction in which the first heat conductive portion overlaps the fuel unit.

18. The nuclear reactor according to claim 12, wherein the second heat conductive portion penetrates the fuel unit and is arranged such that the second heat conductive portion extends to each of outsides on opposite sides to the shield unit.

19. The nuclear reactor according to claim 12, wherein the second heat conductive portion is formed in a form of a rod by laminating plate members that are continuous in a direction in which the form of a rod extends.

20. The nuclear reactor according to claim 19, wherein ends of the plate member of the second heat conductive poition that forms a circumferential surface of the form of a rod are arranged such that the ends are oriented to the outside of the shield unit along a plate surface of the first heat conductive portion in a form of a plate.

21. The nuclear reactor according to claim 1, wherein the heat conductive portion contains graphene.
